(19) United States
(12) Patent Application Publication
(10) Pub. No.: US 2009/0148136 A1
(43) Pub. Date: Jun. 11, 2009

(54) INFORMATION REPRODUCTION APPARATUS AND METHOD, AND COMPUTER PROGRAM

(76) Inventors: Nobuyuki Takakuwa, Saitama (JP); Yosuko Fukuda, Saitama (JP)

Correspondence Address: YOUNG & THOMPSON, 209 Madison Street, Suite 500, ALEXANDRIA, VA, 22314, US

(21) Appl. No.: 12/095,466

(22) PCT Filed: Nov. 27, 2006
(86) PCT No.: PCT/JP2006/323551

§ 371 Date: Jun. 27, 2008

(30) Foreign Application Priority Data
Nov. 30, 2005 (JP) 2005-345326

(51) Int. Cl. H04N 5/85; H04N 5/45

(52) U.S. Cl. 386/126; 348/565; 348/E05.112; 386/E05.064

(57) ABSTRACT

An information reproducing apparatus (200) is provided with: a displaying device (353) for displaying a main picture, a sub-picture of a first type and a sub-picture of a second type; a setting device (355, 360) for setting an identification number of the sub-picture of the first type or the second type, which is selected, to a valid number; and a controlling device (353, 359) for controlling the setting device to set the identification number of the sub-picture of the second type, which is selected before selection of the sub-picture of the first type, to the valid number after the display of the sub-picture of the first type is ended, if the sub-picture of the first type is selected and if the sub-picture of the second type is selected before the selection of the sub-picture of the first type.

### TECHNICAL FIELD

The present invention relates to an information reproducing apparatus for and method of performing reproduction on an information recording medium, such as an optical disc, and a computer program which makes a computer function as such an information reproducing apparatus.

### BACKGROUND ART

As a next-generation optical disc of a DVD, which is becoming popular, a Blu-ray Disc is under development. In the Blu-ray Disc, a blue laser beam is used to record and reproduce record data, wherein the blue laser beam has a shorter wavelength than that of a red laser beam, which is used to record and reproduce the record data on a DVD. Moreover, by shortening the pitch of tracks formed on a recording surface, the Blu-ray Disc attains a recording capacity of about 23 GB in a signal recording layer (refer to patent documents 1 to 3).

On the other hand, a sub-picture, such as a small window, can be displayed with it superimposed on a main picture (in other words, superimposed on one portion of the main picture), such as a movie, recorded on the optical disc described above. As the sub-picture, there are a sub-picture of a Synchronous type (hereinafter referred to as a “Sync type”) and a sub-picture of an Asynchronous type (hereinafter referred to as an “Async type”), in accordance with its display method. In the sub-picture of the Sync type, a display start time point and a display end time point are set in advance with respect to a reproduction time point of the main picture. On the other hand, in the sub-picture of the Async type, the display can be arbitrarily started, in accordance with a user's instruction or the like.

In this case, in order to identify the sub-picture currently selected as the display target from a plurality of types of sub-pictures recorded on the optical disc, a stream number of the selected sub-picture is held in a status register or the like. The stream number held in the status register continues to be held in the status register as long as a new sub-picture is not selected.

Patent document 1: Japanese Patent Application Laid Open NO. 2004-304767
Patent document 2: Japanese Patent Application Laid Open NO. 2004-328450
Patent document 3: Japanese Patent Application Laid Open NO. 2005-269595

### DISCLOSURE OF INVENTION

Subject to be Solved by the Invention

Now, it is assumed that the sub-picture of the Async type is displayed while the sub-picture of the Sync type is displayed. In this case, the stream number of the sub-picture of the Sync type in the status register is rewritten into the stream number of the sub-picture of the Async type. Then, even after the display of the sub-picture of the Async type is ended, the stream number of the sub-picture of the Async type continues to be held in the status register. Thus, although it is desired to display the sub-picture of the Sync type after the display of the sub-picture of the Async type is ended, the sub-picture of the Sync type is not displayed because the stream number of the sub-picture of the Async type is held. At this time, a user needs to give an instruction to display the sub-picture of the Sync type again; however, this may force the user to perform an unnecessary operation, and it is far from preferred.

The subject to be solved by the present invention includes the aforementioned problem as an example. It is therefore an object of the present invention to provide an information reproducing apparatus and method, which can preferably display a sub-picture which is superimposed and displayed on a main picture, and a computer program which makes a computer function as such an information recording apparatus.

### Means for Solving the Subject

The above object of the present invention can be achieved by an information reproducing apparatus provided with: a displaying device for displaying a main picture, a sub-picture of a first type, which is superimposed and displayed on the main picture and whose display can be started at a desired reproduction time point on a reproduction time axis of the main picture, and a sub-picture of a second type, which is superimposed and displayed on the main picture and in which a reproduction time point to start the display is set in advance with respect to the reproduction time axis of the main picture; a setting device for setting an identification number of the sub-picture of the first type or the sub-picture of the second type selected to be superimposed and displayed on the main picture, to a valid number; and a controlling device for controlling the setting device to set the identification number of the sub-picture of the second type, which is selected before selection of the sub-picture of the first type, to the valid number after the display of the sub-picture of the first type is ended, if the sub-picture of the first type is selected and if the identification number of the sub-picture of the second type is set as the valid number before the selection of the sub-picture of the first type.

The above object of the present invention can be also achieved by an information reproducing method in an information reproducing apparatus provided with: a displaying device for displaying a main picture, a sub-picture of a first type, which is superimposed and displayed on the main picture and whose display can be started at a desired reproduction time point on a reproduction time axis of the main picture, and a sub-picture of a second type, which is superimposed and displayed on the main picture and in which a reproduction time point to start the display is set in advance with respect to the reproduction time axis of the main picture; and a setting device for setting an identification number of the sub-picture of the first type or the sub-picture of the second type selected to be superimposed and displayed on the main picture, to a valid number, the information reproducing method provided with: a displaying process of displaying at least one of the main picture the sub-picture of the first type, and the sub-picture of the second type; and a controlling process of controlling the setting device to set the identification number of the sub-picture of the second type, which is selected before selection of the sub-picture of the first type, to the valid number after the display of the sub-picture of the first type is ended, if the sub-picture of the first type is selected and if the identification number of the sub-picture of the second type is set as the valid number before the selection of the sub-picture of the first type.

The above object of the present invention can be also achieved by a computer program for reproduction control and for controlling a computer provided in the information reproducing apparatus of the present invention, the computer program making the computer function as at least the controlling device.

These effects and other advantages of the present invention will become more apparent from the embodiments explained below.

### BRIEF DESCRIPTION OF DRAWINGS

FIG. 1 is a block diagram conceptually showing the basic structure of an information recording/reproducing apparatus in an example.

FIG. 2 is a data structure diagram conceptually showing the logical structure of a title table.

FIG. 3 is a data structure diagram conceptually showing the logical structure of a play list.

FIG. 4 is a cross sectional view showing a new optical disc and a graph showing tracking polarity.

FIG. 5 is a data structure diagram conceptually showing the logical structure of the play list in employing PinP in which a second picture, which is a sub-picture, is superimposed and displayed on at least one portion of a first picture, which is a main picture.

FIG. 6 is a timing chart conceptually showing a flow of the display of the first picture and the second picture along a time axis when the second picture of a Sync type is superimposed and displayed on the first picture.

FIG. 7 is a timing chart conceptually showing a flow of the display of the first picture and the second picture along the time axis when the second picture of the Sync type is superimposed and displayed on the first picture.

FIG. 8 is a plan view conceptually showing the second picture which is superimposed and displayed on the first picture.

FIG. 9 is a flowchart conceptually showing a flow of the operation of the information recording/reproducing apparatus in the example.

FIG. 10 is a timing chart conceptually showing a flow of the display of the first picture and the second picture along the time axis.

### DESCRIPTION OF REFERENCE CODES

10 title table
12 pointer to play list
30 play list
31 play item
33 sub-play item
100 optical disc
200 information recording/reproducing apparatus
352 optical pickup
353 signal recording/reproducing device
354, 359 CPU
355, 360 memory

### BEST MODE FOR CARRYING OUT THE INVENTION

Hereinafter, the best mode for carrying out the present invention will be explained in embodiments of the information reproducing apparatus and method, and the computer program of the present invention with reference to the drawings.

### Embodiment of Information Reproducing Apparatus

An embodiment of the information reproducing apparatus of the present invention is provided with: a displaying device for displaying a main picture, a sub-picture of a first type, which is superimposed and displayed on the main picture and whose display can be started at a desired reproduction time point on a reproduction time axis of the main picture, and a sub-picture of a second type, which is superimposed and displayed on the main picture and in which a reproduction time point to start the display is set in advance with respect to the reproduction time axis of the main picture; a setting device for setting an identification number of the sub-picture of the first type or the sub-picture of the second type selected to be superimposed and displayed on the main picture, to a valid number; and a controlling device for controlling the setting device to set the identification number of the sub-picture of the second type, which is selected before selection of the sub-picture of the first type, to the valid number after the display of the sub-picture of the first type is ended, if the sub-picture of the first type is selected and if the identification number of the sub-picture of the second type is set as the valid number before the selection of the sub-picture of the first type.

According to the embodiment of the information reproducing apparatus of the present invention, the main picture, such as a movie, can be displayed on a display or the like by the operation of the displaying device. Moreover, by the operation of the displaying device, the sub-picture of the first type can be displayed with it superimposed on the main picture (in other words, superimposed on one portion of the main picture). The sub-picture of the first type is a sub-picture whose display can be started at the desired reproduction time point on the reproduction time axis of the main picture, and it is referred to as e.g. a sub-picture of an Async type. That is, the sub-picture of the first type is a sub-picture whose reproduction time point to start the display is not set in advance, and which can be displayed at an arbitrary reproduction time point in accordance with a user's instruction. Moreover, by the operation of the displaying device, the sub-picture of the second type, which is different from the sub-picture of the first type, can be displayed with it superimposed on the main picture (in other words, superimposed on one portion of the main picture). The sub-picture of the second type is a sub-picture whose reproduction time point to start the display (moreover, a reproduction time point to end the display) is set in advance with respect to the reproduction time axis of the main picture, and it is referred to as e.g. a sub-picture of a Sync type.

At this time, the identification number of the sub-picture of the first type or the sub-picture of the second type, which is the display target (for example, which is selected as the display target by the user or the like) is set to the valid number by the operation of the setting device. The displaying device superimposes and displays the sub-picture, which is specified by the identification number set to the valid number by the setting device, on the main picture.

In particular in the embodiment, if the sub-picture of the first type is selected as the sub-picture to be superimposed and displayed on the main picture and if the sub-picture of the second type is previously selected as the sub-picture to be superimposed and displayed on the main picture before the selection of the sub-picture of the first type, the setting device is controlled by the operation of the controlling device to set the identification number of the sub-picture of the second type, which is previously selected before the selection of the sub-picture of the first type, to the valid number again after the display of the sub-picture of the first type is ended. More specifically, if the sub-picture of the first type is selected as the sub-picture to be superimposed and displayed on the main picture and if the identification number of the sub-picture of the second type is previously set to the valid number before the selection of the sub-picture of the first type, the display of the sub-picture of the first type is started and the identification number of the sub-picture of the first type is set to the valid number, by the operation of the controlling device. At this time, the identification number of the sub-picture of the second type, which is previously set to the valid number before the sub-picture of the first type is selected, is set to e.g. an invalid number or the like. After the display of the sub-picture of the first type is ended, the identification number of the sub-picture of the second type, which is previously set to the valid number before the sub-picture of the first type is selected (in other words, which is set to e.g. the invalid number or the like), is set to the valid number again.

Thus, after the display of the sub-picture of the first type is ended, the sub-picture of the second type which has been displayed before is superimposed and displayed on the main picture. In other words, even if the user gives an instruction to display the sub-picture of the first type when the sub-picture of the second type is displayed or after the display of the sub-picture of the second type is ended, the sub-picture of the second type is automatically displayed after the display of the sub-picture of the first type is ended. Therefore, the user does not have to give the instruction to display the sub-picture of the first type again.

Incidentally, the sub-picture of the first type is often used as e.g. a background picture of a popup menu because it can be freely displayed at a reproduction time point desired by the user. On the other hand, the sub-picture of the second type is often used as a picture closely related to the main picture (e.g. strongly related to a scene of the main picture) because it is displayed at the reproduction time point determined in advance. Thus, even if the user who watches the main picture as well as the sub-picture of the second type happens to display the popup menu, which uses the sub-picture of the first type as the background picture, and performs some operation or the like, the user can watch the main picture with the sub-picture of the second type again without any particular operation.

As described above, according to the embodiment of the information reproducing apparatus of the present invention, it is possible to preferably display the sub-picture that is superimposed and displayed on the main picture.

Incidentally, as one specific example of the information reproducing apparatus for setting the identification number to the valid number, the following aspect can be listed. Specifically, it is the information reproducing apparatus provided with: a displaying device for displaying a main picture, a sub-picture of a first type, which is superimposed and displayed on the main picture and whose display can be started at a desired reproduction time point on a reproduction time axis of the main picture, and a sub-picture of a second type, which is superimposed and displayed on the main picture and in which a reproduction time point to start the display is set in advance with respect to the reproduction time axis of the main picture; a storing device (in other words, a valid storing device) for storing an identification number of the sub-picture of the first type or the sub-picture of the second type selected to be superimposed and displayed on the main picture; and a controlling device for controlling the storing device to store the identification number of the sub-picture of the second type, which is selected before selection of the sub-picture of the first type, instead of the identification number of the sub-picture of the first type, after the display of the sub-picture of the first type is ended, if the sub-picture of the first type is selected and if the sub-picture of the second type is selected before the selection of the sub-picture of the first type.

In this aspect, if the sub-picture of the first type is selected as the sub-picture to be superimposed and displayed on the main picture and if the sub-picture of the second type is previously selected as the sub-picture to be superimposed and displayed on the main picture before the selection of the sub-picture of the first type, the storing device is controlled by the operation of the controlling device to store the identification number of the sub-picture of the second type, which is previously selected before the selection of the sub-picture of the first type, instead of the identification number of the sub-picture of the first type, after the display of the sub-picture of the first type is ended. More specifically, if the sub-picture of the first type is selected as the sub-picture to be superimposed and displayed on the main picture and if the identification number of the sub-picture of the second type is previously stored in the storing device before the selection of the sub-picture of the first type, the display of the sub-picture of the first type is started and the identification number of the sub-picture of the first type is stored into the storing device, by the operation of the controlling device. After the display of the sub-picture of the first type is ended, the identification number of the sub-picture of the first type is destroyed, and the identification number of the sub-picture of the second type, which is previously stored in the storing device before the sub-picture of the first type is selected, is stored into the storing device again.

By this, it is possible to preferably receive the aforementioned various benefits.

In one aspect of the information reproducing apparatus of the present invention, the controlling device controls the setting device to continue to set the identification number of the sub-picture of the second type to the valid number after the display of the sub-picture of the second type is ended, if the sub-picture of the second type is selected.

According to this aspect, it is possible to preferably display the sub-picture of the second type, with it superimposed on the main picture.

In another aspect of the information reproducing apparatus of the present invention, the controlling device controls the setting device to continue to set the identification number of the sub-picture of the first type to the valid number after the display of the sub-picture of the first type is ended, if the sub-picture of the first type is selected and if the sub-picture of the second type is not selected before the selection of the sub-picture of the first type.

According to this aspect, if the identification number of the sub-picture of the second type is not set to the valid number before the sub-picture of the first type is selected, the identification number of the sub-picture of the second type, which is set to the valid number before the selection of the sub-picture of the first type, is not set to the valid number even after the display of the sub-picture of the first type is ended. In this case, the identification number of the sub-picture of the first type which is selected continues to be set to the valid number, as it is. As a result, as described above, it is possible to preferably display the sub-picture, which is superimposed and displayed on the main picture.

In another aspect of the information reproducing apparatus of the present invention, the controlling device controls the setting device to set the identification number of the sub-picture of the second type, which is set as the valid number before the selection of the sub-picture of the first type, to the valid number again after the display of the sub-picture of the first type is ended, if the sub-picture of the first type is selected and if the identification number of the sub-picture of the second type is set to the valid number before the selection of the sub-picture of the first type.

According to this aspect, as described above, it is possible to preferably display the sub-picture, which is superimposed and displayed on the main picture.

In another aspect of the information reproducing apparatus of the present invention, it is further provided with a first judging device for judging whether the sub-picture of the first type is selected or the sub-picture of the second type is selected.

According to this aspect, it is possible to preferably distinguish between the sub-picture of the first type and the sub-picture of the second type. As a result, as described above, it is possible to preferably display the sub-picture, which is superimposed and displayed on the main picture.

In another aspect of the information reproducing apparatus of the present invention, it is further provided with a second judging device for judging, if the sub-picture of the first type is selected, whether or not the sub-picture of the second type is selected before the selection.

According to this aspect, when the sub-picture of the first type is selected, it is possible to preferably judge whether or not the sub-picture of the second type is effectively selected before the selection of the sub-picture of the first type (i.e. whether or not the identification number of the sub-picture of the second type, which is valid, is stored in the storing device before the selection of the sub-picture of the first type). As a result, as described above, it is possible to preferably display the sub-picture, which is superimposed and displayed on the main picture.

### Embodiment of Information Reproducing Method

An embodiment of the information reproducing method of the present invention is an information reproducing method in an information reproducing apparatus provided with: a displaying device for displaying a main picture, a sub-picture of a first type, which is superimposed and displayed on the main picture and whose display can be started at a desired reproduction time point on a reproduction time axis of the main picture, and a sub-picture of a second type, which is superimposed and displayed on the main picture and in which a reproduction time point to start the display is set in advance with respect to the reproduction time axis of the main picture; and a setting device for setting an identification number of the sub-picture of the first type or the sub-picture of the second type selected to be superimposed and displayed on the main picture, to a valid number, the information reproducing method provided with: a displaying process of displaying at least one of the main picture the sub-picture of the first type, and the sub-picture of the second type; and a controlling process of controlling the setting device to set the identification number of the sub-picture of the second type, which is selected before selection of the sub-picture of the first type, to the valid number after the display of the sub-picture of the first type is ended, if the sub-picture of the first type is selected and if the identification number of the sub-picture of the second type is set as the valid number before the selection of the sub-picture of the first type.

According to the embodiment of the information reproducing method of the present invention, it is possible to receive the same benefits as those of the aforementioned information reproducing apparatus of the present invention.

In response to the various aspects of the aforementioned information reproducing apparatus of the present invention, the information reproducing method of the present invention can employ various aspects.

### Embodiment of Computer Program

An embodiment of the computer program of the present invention is a computer program for reproduction control and for controlling a computer provided in the aforementioned information reproducing apparatus of the present invention (including its various aspects), the computer program making the computer function as at least the controlling device.

According to the computer program of the present invention, the aforementioned information reproducing apparatus of the present invention (including its various aspects) can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the aforementioned information reproducing apparatus of the present invention, the computer program of the present invention can also employ various aspects.

The above object of the present invention can be also achieved by a computer program product in a computer-readable medium for tangibly embodying a program of instructions executable by a computer provided in the aforementioned information reproducing apparatus of the present invention (including its various aspects), the computer program product making the computer function as the controlling device.

According to the computer program product of the present invention, the aforementioned information reproducing apparatus of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned information reproducing apparatus of the present invention.

Incidentally, in response to the various aspects of the aforementioned information reproducing apparatus of the present invention, the computer program product of the present invention can also employ various aspects.

These effects and other advantages of the present invention will become more apparent from the example explained below.

As explained above, according to the embodiment of the information reproducing apparatus of the present invention, it is provided with the displaying device, the setting device, and the controlling device.

According to the embodiment of the information reproducing method of the present invention, it is provided with the displaying process and the controlling process.

According to the embodiment of the computer program of the present invention, it makes a computer function as one portion of the embodiment of the information reproducing apparatus of the present invention.

Therefore, it is possible to preferably display the sub-picture that is superimposed and displayed on the main picture.

### EXAMPLE

Hereinafter, the preferred example of the present invention will be explained with reference to the drawings.

(1) Basic Structure of Information Recording/Reproducing Apparatus

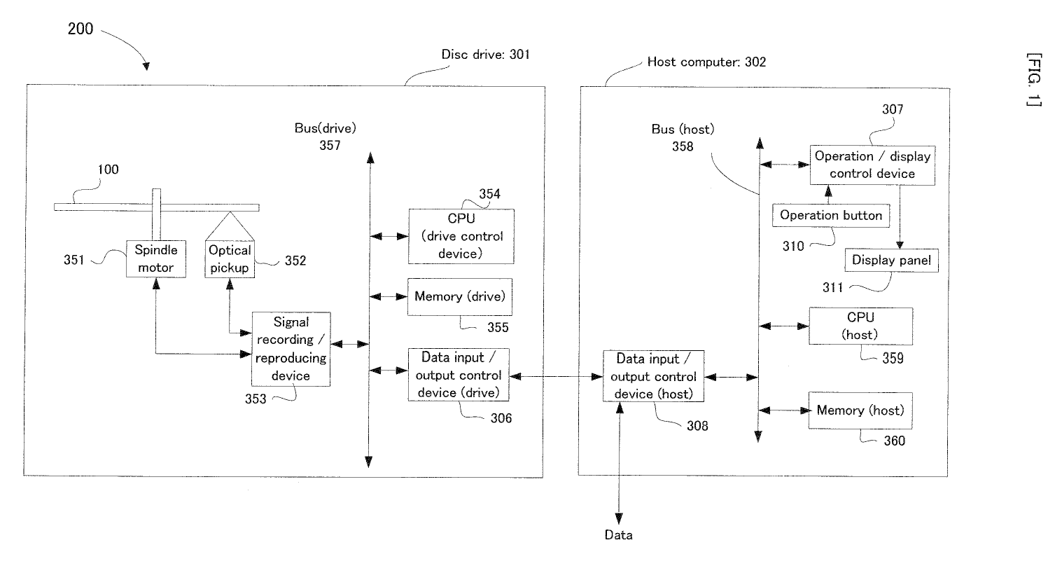

Firstly, with reference to FIG. 1, a description will be given on the basic structure of an information recording/reproducing apparatus, as an example of the information reproducing apparatus of the present invention. FIG. 1 is a block diagram conceptually showing the basic structure of an information recording/reproducing apparatus 200 in the example. Incidentally, the information recording/reproducing apparatus 200 has a function of recording data onto an optical disc 100 and a function of reproducing the data recorded on the optical disc 100.

As shown in FIG. 1, the information recording/reproducing apparatus 200 is provided with: a disc drive 301 on which the optical disc 100 is actually loaded and on which data recording and data reproduction are performed; and a host computer 302, such as a personal computer, for controlling the data recording and reproduction with respect to the disc drive 301.

The disc drive 301 is provided with: the optical disc 100; a spindle motor 351; an optical pickup 352; a signal recording/reproducing device 353; a CPU (drive control device) 354; a memory 355; a data input/output control device 306; and a bus 357. Moreover, the host computer 302 is provided with: a CPU 359; a memory 360; an operation/display control device 307; an operation button 310; a display panel 311; and a data input/output control device 308.

The spindle motor 351 is intended to rotate and stop the optical disc 100, and operates upon accessing the holographic recording medium 1. More specifically, the spindle motor 351 is adapted to rotate the optical disc 100 at a predetermined speed and stop it, under spindle servo from a not-illustrated servo unit or the like.

The optical pickup 352 is provided with e.g. a semiconductor laser diode, a collimator lens, an objective lens, and the like, in order to perform the recording and the reproduction on the optical disc 100. More specifically, the optical pickup 352 irradiates the optical disc 100 with a laser beam LB with a first power as reading light in the reproduction, and with a second power and with it modulated as writing light in the recording.

The signal recording/reproducing device 353 constitutes one specific example of the “displaying device” of the present invention, and controls the spindle motor 351 and the optical pickup 352, to thereby perform the recording and the reproduction on the optical disc 100. More specifically, the signal recording/reproducing device 353 is provided with e.g. a laser diode driver (LD driver), a head amplifier, and the like. The laser diode driver generates e.g. a driving pulse and drives the semiconductor laser element disposed in the optical pickup 352. The head amplifier amplifies an output signal of the optical pickup 352, i.e. reflected light of the laser beam LB, and outputs the amplified signal.

The memory 355 is used in the general data processing and an OPC process on the disc drive 301, including a buffer area for the record/reproduction data, an area used as an intermediate buffer when data is converted into the data that can be used on the signal recording/reproducing device 353, and the like. Moreover, the memory 355 is provided with: a ROM area into which a program for performing an operation as the recorder equipment, i.e. firmware, is stored; a buffer for temporary storage of the record/reproduction data; a RAM area into which a parameter required for the operation of a firmware program or the like is stored; and the like.

The CPU (drive control device) 354 is connected to the signal recording/reproducing device 353 and the memory 355 through the bus 357, and controls the entire disc drive 301 by giving an instruction to various controlling devices. Typically, software or firmware for operating the CPU 354 is stored in the memory 355.

The data input/output control device 306 controls the input/output of the data from the exterior with respect to the disc drive 301, to thereby perform storage to and export from the data buffer on the memory 355. A drive control command issued from the external host computer 302 connected to the disc drive 301 through an interface, such as a SCSI and an ATAPI, is transmitted to the CPU 354 through the data input/output control device 306. Moreover, the data is also exchanged with the host computer 302 through the data input/output control device 306, in the same manner.

The operation/display control device 307 receives an operation instruction and performs display with respect to the host computer 302, and transmits an instruction by the operation button 310, such as an instruction to record, to the CPU 359. The CPU 359 may transmit a control command to the information recording/reproducing apparatus 200, through the data input/output control device 308, on the basis of instruction information from the operation/display control device 307, to thereby control the entire disc drive 301. In the same manner, the CPU 359 can transmit a command for requesting the disc drive 301 to transmit an operational state to the host, with respect to the disc drive 301. By this, the operational state of the disc drive 301, such as during recording, can be recognized, so that the CPU 359 can output the operational state of the disc drive 301 to the display panel 311, such as a fluorescent tube and an LCD, through the operation/display control device 307.

The memory 360 is an internal memory apparatus used by the host computer 302, and it is provided with: a ROM area in which a firmware program, such as BIOS (Basic Input/Output System), is stored; a RAM area in which variables necessary for the operation of an operating system and an application program or the like are stored; and the like. Moreover, the memory 360 may be connected to an external memory apparatus, such as a not-illustrated hard disk, through the data input/output control device 308.

One specific example used by combining the disc drive 301 and the host computer 302, as explained above, is household equipment, such as recorder equipment for recording and reproducing video images. The recorder equipment records a video signal from a broadcast reception tuner and an external connection terminal, onto a disc. The operation as the recorder equipment is performed by executing a program stored in the memory 360, on the CPU 359. Moreover, in another specific example, the disc drive 301 is a disc drive (hereinafter referred to as a “drive”, as occasion demands), and the host computer 302 is a personal computer and a work station. The host computer, such as the personal computer, and the drive are connected through the data input/output control devices 306 and 308, such as the SCSI and the ATAPI, and application, such as writing software, installed in the host computer 302 controls the disc drive 301.

(2) Logical Structure of Data recorded on Optical Disc

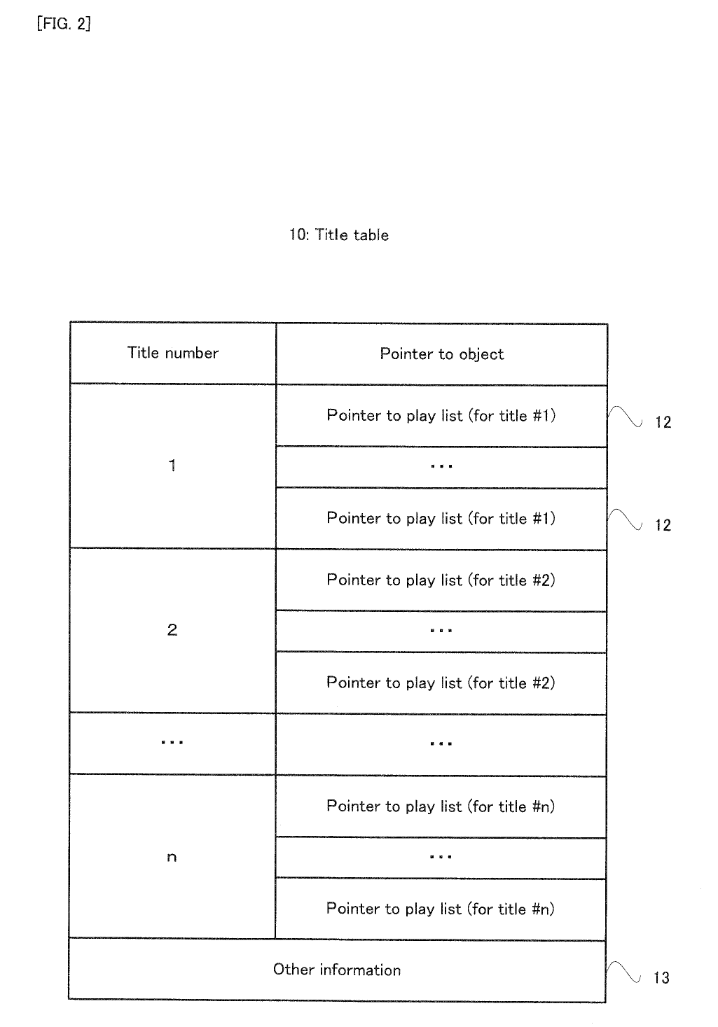

Next, with reference to FIG. 2 to FIG. 8, a description will be given on the logical structure of the data on the optical disc 100.

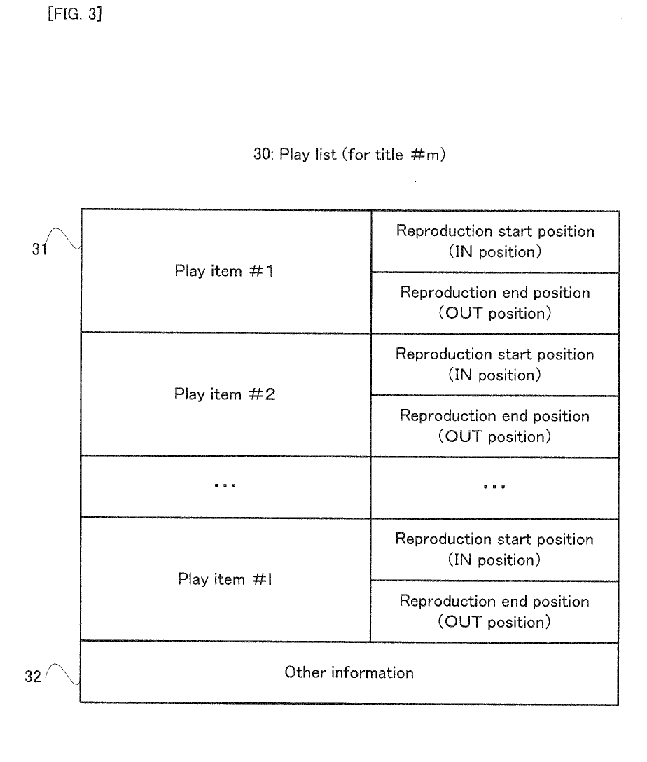

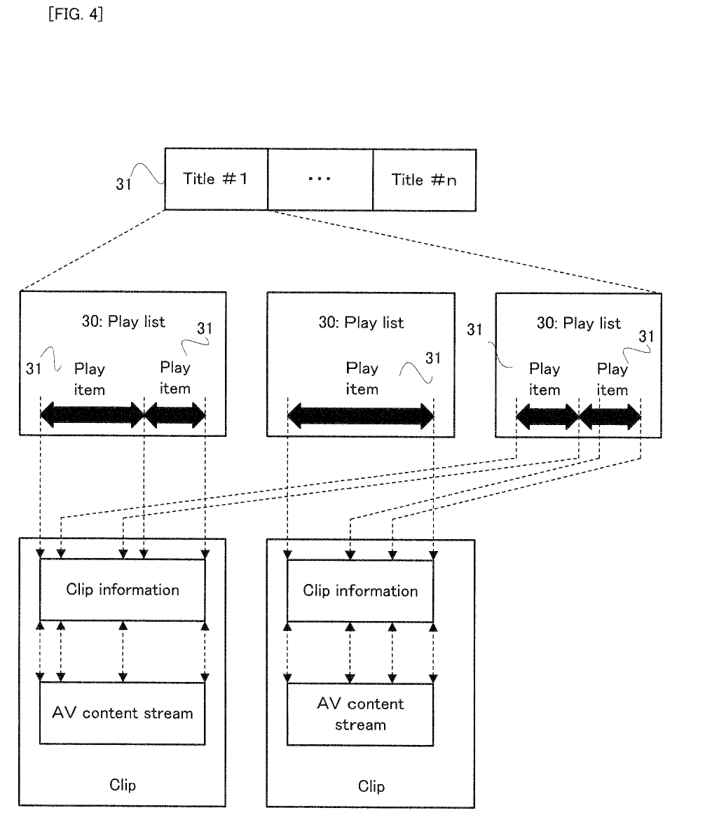

Firstly, with reference to FIG. 2 to FIG. 4, a description will be given on the basic structure of the logical structure of the data on the optical disc 100. FIG. 2 is a data structure diagram conceptually showing the logical structure of a title table. FIG. 3 is a data structure diagram conceptually showing the logical structure of a play list. FIG. 4 is a data structure conceptually showing a hierarchy relationship of the logical structure of the data.

As shown in FIG. 2, a title table 10 is recorded on the optical disc 100, wherein the title table 10 indicates objects that constitute a plurality of titles. Here, the title is AV content unit which has a logically large group, such as one movie and one TV program. As described later, the title is an AV content reproduction unit in which a plurality of “play lists” are continuously executed.

On the title table 10, there are recorded pointers 12 which indicate the storage positions of the play lists which constitute each title (for titles #1 to #n), in each of the title numbers #1 to #n (wherein n is an integer or 1 or more) for identifying the title. Here, the “play list” is a file in which information necessary for the reproduction of the AV content is stored. As described later, the play list is provided with a plurality of “play items” in each of which information about the reproduction range of the AV content is stored to access the AV content.

Moreover, on the title table 10, there is recorded other information except the aforementioned pointers 12.

Incidentally, FIG. 2 exemplifies the title table 10 in the case where the plurality of titles are recorded on the optical disc 100. If one title is recorded on the optical disc 100, the present invention employs such construction that the pointers 12 to the playlists which constitute the one title are recorded.

Moreover, FIG. 2 exemplifies the title table 10 in which the reproduction unit which is obtained by continuously executing the plurality of play lists, is set as one title; however, it is obvious that a reproduction unit which is obtained by executing a single play list may be set as one title.

As shown in FIG. 3, the play list (for title #m (wherein 1≦m≦n)) 30 whose storage position is indicated by the pointer 12 recorded in the title table 10, includes a plurality of play items 31 and other information 32.

Each of the plurality of play items 31 includes a reproduction start position (in other words, an IN position) of the AV content and a reproduction end position (in other words, an OUT position) of the AV content. Incidentally, the reproduction start position and the reproduction end position are preferably indicated by a time stamp (i.e. a reproduction time length or a reproduction time point) on a reproduction time axis of the AV content.

Moreover, the play list 30 preferably includes the position(s) of one or a plurality of chapters included in the AV content.

As shown in FIG. 4, the data structure explained in FIG. 2 and FIG. 3 has a hierarchic relationship. That is, one title is provided with one or a plurality of play lists 30, and one play list 30 is provided with one or a plurality of play items 31.

Then, the play item 31 indicates an access point in a clip by the reproduction start position and the reproduction end position described above. Incidentally, the “clip” in the example indicates a pair of one AV content stream file (i.e. an actual data file of the AV content, for example, a MPEG 2 transport stream) and clip information, which is information corresponding thereto. Moreover, the data file of the clip information is referred to as a clip information file.

The reproduction start position and the reproduction end position shown as the time stamp by the play item 31 are converted to address information, at which decoding is to be started in the AV content stream file, by using the clip information file. Thus, the clip information preferably includes a table or the like which indicates a correspondence relationship between the time stamp and the address information.

For example, in FIG. 4, the title #1 shown at the first from the left is provided with three play lists 30. The first play list 30, shown on the left side in FIG. 4 of the three play lists, is provided with two play items 31. The two play items 31 refer to a former half portion and a latter half portion of an AV content stream included in the first clip shown on the left side in FIG. 4. Thus, if the first play list 30 is selected, the former half portion and the latter half portion of the AV content stream included in the first clip are reproduced.

Moreover, the second play list 30 shown on the middle side in FIG. 4 of the three play lists 30 is provided with one play item. The one play item 31 refers to an entire AV content stream included in the second clip shown on the right side in FIG. 4. Thus, if the second play list 30 is selected, the entire AV content stream included in the second clip is reproduced.

Moreover, the third play list 30 shown on the right side in FIG. 4 of the three play lists is provided with two play items 31. The two play items 31 refer to one portion of the AV content stream included in the first clip and one portion of the AV content stream included in the second clip. Thus, if the third play list 30 is selected, one portion of the AV content stream included in the first clip and one portion of the AV content stream included in the second clip are reproduced.

As described above, from the viewpoint of the logical structure of the data recorded on the optical disc 100, the information recording/reproducing apparatus 200 in the example reproduces the AV content recorded on the topical disc 100 by following the hierarchical data structure shown in FIG. 4 as needed.

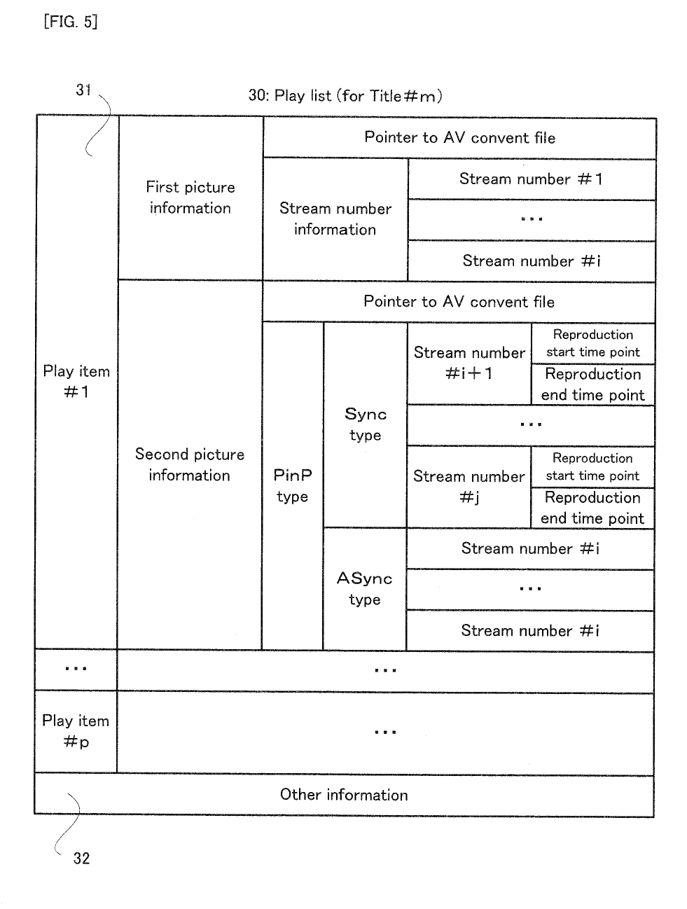

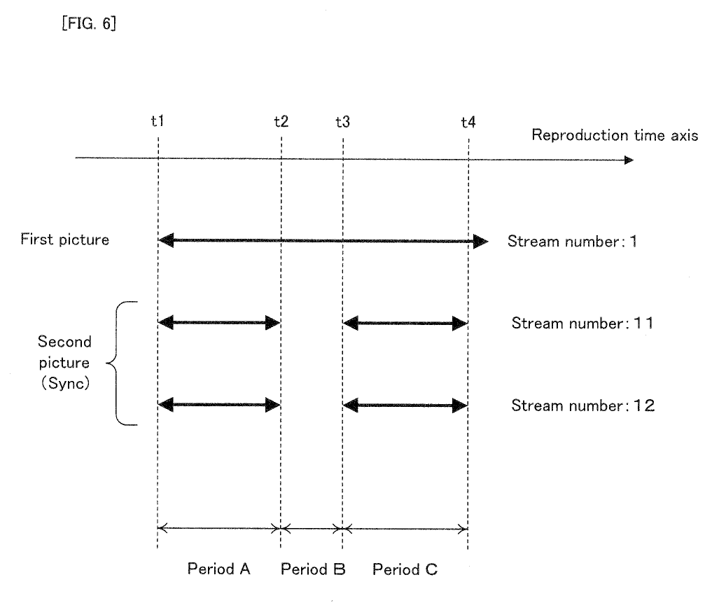

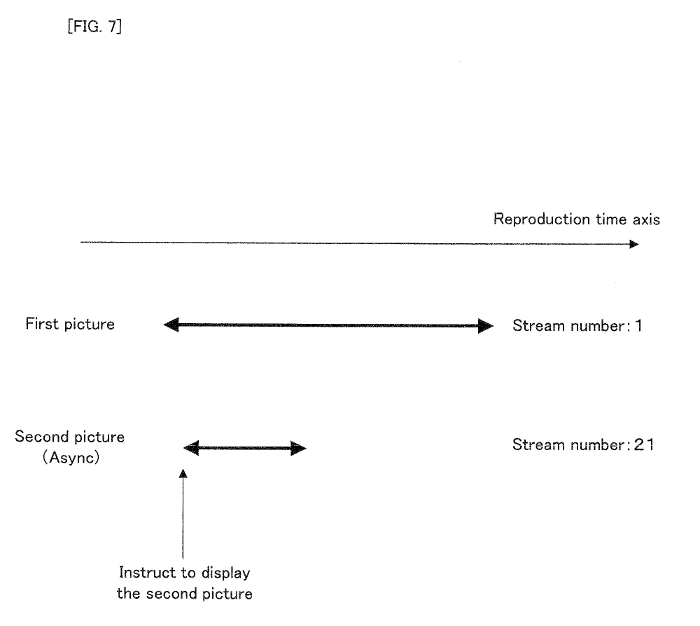

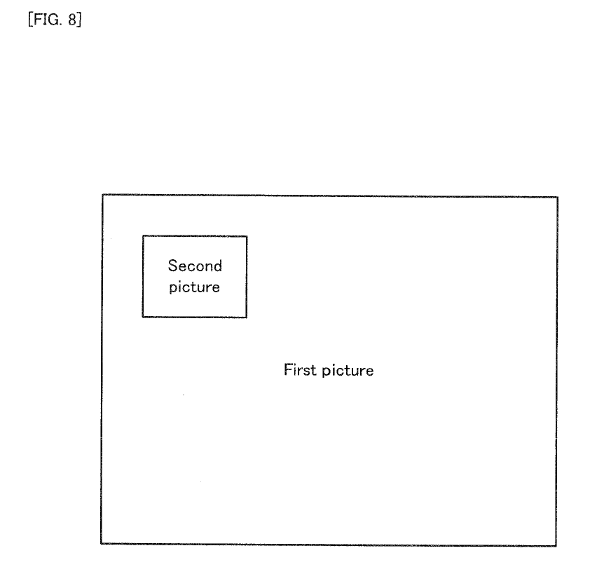

Next, with reference to FIG. 5 to FIG. 8, a more specific description will be given on an aspect of the display of a second picture and the logical structure of the play list 30 in employing PinP in which the second picture, which is a sub-picture, is superimposed and displayed (in other words, reproduced) on at least one portion of a first picture, which is a main picture, of the AV content. FIG. 5 is a data structure diagram conceptually showing the logical structure of the play list in employing PinP in which the second picture, which is the sub-picture, is superimposed and displayed on at least one portion of the first picture, which is the main picture. FIG. 6 is a timing chart conceptually showing a flow of the display of the first picture and the second picture along a time axis when the second picture of a Sync type is superimposed and displayed on the first picture. FIG. 7 is a timing chart conceptually showing a flow of the display of the first picture and the second picture along the time axis when the second picture of the Async type is superimposed and displayed on the first picture. FIG. 8 is a plan view conceptually showing the second picture which is superimposed and displayed on the first picture.

As shown in FIG. 5, the play list 30 in employing PinP includes one or a plurality of play items 31 (#1 to #p: wherein p is an integer of 1 or more) including information about the first picture and information about the second picture.

The play item 31 includes a pointer to an AV content file corresponding to the first picture and stream number information about the first picture. For example, in the example shown in FIG. 5, the play item 31 specifies streams with the stream number #1 to the stream number #i as the first picture. Incidentally, the reproduction start time point and the reproduction end time point shown in FIG. 3 are preferably defined in each stream, which are not illustrated.

Moreover, the play item 31 includes a pointer to an AV content file corresponding to the second picture and stream number information about the second picture, in addition to the stream number information about the first picture. For example, in the example shown in FIG. 5, the play item 31 specifies streams with the stream number #i+1 to the stream number #k as the second picture.

In particular, in the example, as the second picture, there are a second picture of a Sync type and a second picture of an Async type, in accordance with its display method. In the second picture of the Sync type, the display start time point and the display end time point are set in advance on the basis of the reproduction time point of the first picture. On the other hand, in the second picture of the Async type, the reproduction can be started at an arbitrary reproduction time point in accordance with an instruction of a user or the like. In the example shown in FIG. 5, streams with the stream number #i+1 to the stream number #j are specified as the second picture of the Sync type, and streams with the stream number #j+1 to the stream number #k are specified as the second picture of the Async type.

As described above, by including one or a plurality of play items 31, which include(s) the information about the first picture and the information about the second picture, it is possible to reproduce another stream that is not multiplexed in the clip for the first picture, in synchronization with the stream for the first picture.

Specifically, in case of the second picture of the Sync type, as shown in FIG. 6, while the first picture with the stream number #1 is reproduced, the second picture with the stream number #11 or #12 is reproduced in parallel. The stream numbers of the first picture and the second picture which are the display targets are stored into the memory 355 or the memory 360, which constitutes one specific example of the “storing device” or the “setting device” of the present invention. For example, if the second picture with the stream number #11 is reproduced in parallel while the first picture with the stream number #1 is reproduced, the stream number #1 and the stream number #11 are stored into the memory 355 or the memory 360.

The reproduction of the second picture with the stream number #11 or #12 starts at a reproduction time point t1 and ends at a reproduction time point t2. After that, the reproduction starts at a reproduction time point t3, and the reproduction ends at a reproduction time point t4. Therefore, if a user gives an instruction to display the second picture in a period A between the reproduction time point t1 and the reproduction time point t2 and a period C between the reproduction time point t3 and the reproduction time point t4, the second picture is displayed on a display. Moreover, if the user gives an instruction to display the second picture in a period B between the reproduction time point t2 and the reproduction time point t3, the second picture is displayed on the display at the reproduction time point t3 after the instruction.

At this time, under the control of the CPU 354 or the CPU 359, which constitutes one specific example of the “controlling device” of the present invention, the stream number of the second picture continues to be stored as a valid stream number in the memory 355 or the memory 360 even if the reproduction of the second picture is ended at the reproduction time point t2. For example, if the second picture with the stream number #11 is being reproduced, the stream number #11 continues to be stored as the valid stream number in the memory 355 or the memory 360 even in the period B after the reproduction time point t2. As a result, the second picture with the stream number #11 is automatically reproduced at the reproduction time point t3.

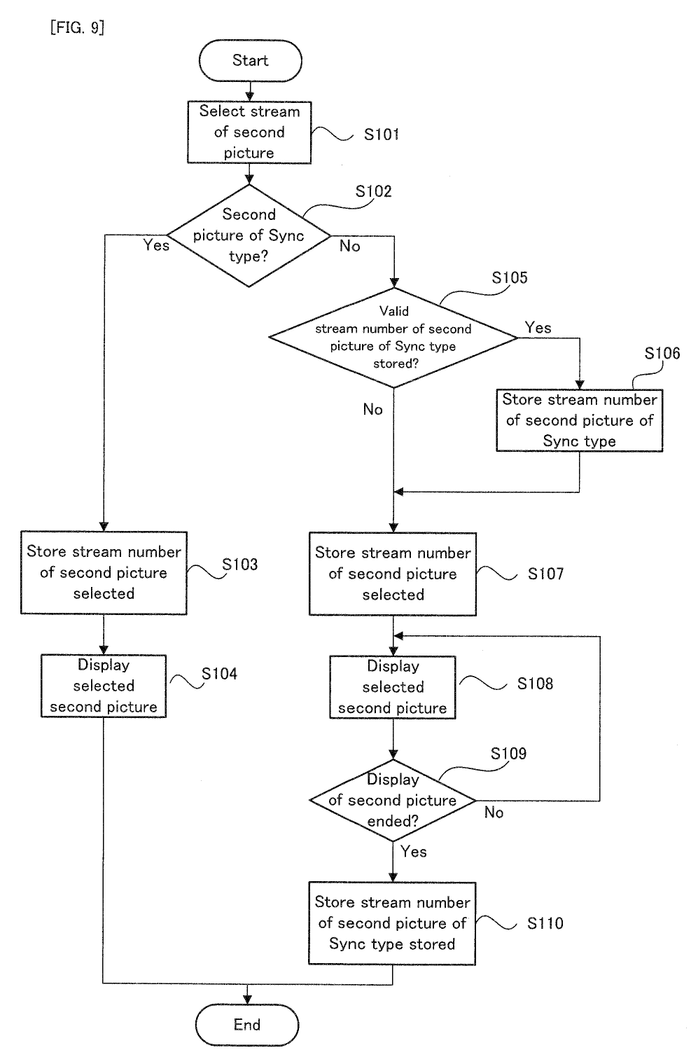

Alternatively, in case of the second picture of the Async type, as shown in FIG. 7, if the user gives an instruction to display the second picture with the stream number #21, the second picture with the stream number #21 is displayed in parallel with the first picture with the stream number #1, regardless of the reproduction time point at which the instruction is given. If the user gives an instruction to end the display of the second picture or if the reproduction period of the second picture is over, the display of the second picture is ended. If the second picture of the Async type is reproduced, the stream number continues to be stored as the valid stream number in the memory 355 or the memory 360, or is destroyed, or continues to be stored as an invalid stream number, according to a flow shown in FIG. 9.

As a result, as shown in FIG. 8, a small window of the second picture is superimposed and displayed simultaneously on one portion of the first picture.

Incidentally, in the example, the memory 355 or the memory 360 stores therein one stream number of the first picture and one stream number of the second picture as the valid stream number. That is, a plurality of stream numbers of the first pictures are not stored as the valid stream numbers in the memory 355 or the memory 360. In the same manner, a plurality of stream numbers of the second pictures are not stored as the valid stream numbers in the memory 355 or the memory 360. However, it may be constructed such that the plurality of stream numbers of the first pictures are stored as the valid stream numbers in the memory 355 or the memory 360. In the same manner it may be constructed such that the plurality of stream numbers of the second pictures are stored as the valid stream numbers in the memory 355 or the memory 360.

(3) Operation Principle of Information Recording/Reproducing Apparatus

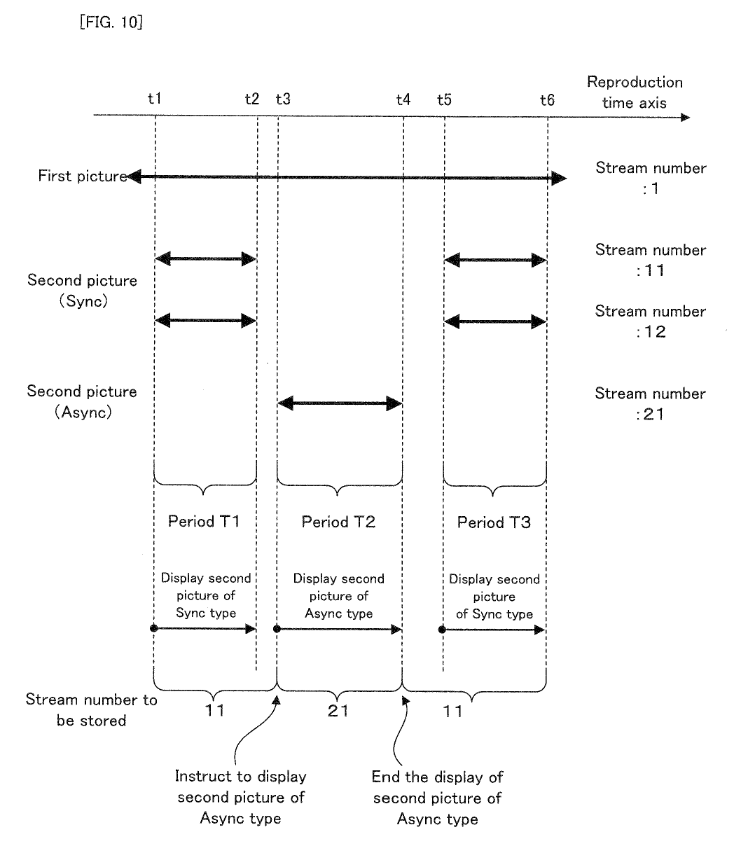

Next, with reference to FIG. 9 and FIG. 10, a description will be given on the more detailed aspect of the reproduction operation (specifically, the aspect of the operation of displaying the second picture) of the information recording/reproducing apparatus 200 in the example. FIG. 9 is a flowchart conceptually showing a flow of the operation of the information recording/reproducing apparatus in the example. FIG. 10 is a timing chart conceptually showing a flow of the display of the first picture and the second picture along the time axis.

Incidentally, the flowchart shown in FIG. 9 indicates the operation of display the second picture when the title (in other words, the AV content) to be reproduced has been already selected by the user and the first picture included in the title is displayed.

As shown in FIG. 9, the stream of the second picture is selected (step S101). In other words, the second picture to be superimposed and displayed on the first picture is selected. The aforementioned selection includes direct selection of the second picture by the user and selection of the second picture by control such as a setting of an initial value for the Sync type (e.g. selection of the second picture based on the setting of the initial value of the stream number by a program for reproducing the AV content (e.g. a Java program or the like)).

After that, under the control of the CPU 354 or the CPU 359 which constitutes one specific example of the “first judging device” of the present invention, it is judged whether or not the type of the second picture selected is the Sync type (step S102).

As a result of the judgment in the step S102, if it is judged that the type of the second picture is the Sync type (the step 102: Yes), under the control of the CPU 354 or the CPU 359 which constitutes one specific example of the “controlling device” of the present invention, the stream number of the second picture of the Sync type selected in the step S101 is stored as the valid stream number into the memory 355 or the memory 360 (step S103). After that, the second picture is superimposed and displayed on the first picture as explained in FIG. 6. At this time, the stream number of the second picture of the Sync type continues to be stored as the valid stream number in the memory 355 or the memory 360, under the control of the CPU 354 or the CPU 359, as described above.

On the other hand, as a result of the judgment in the step S102, if it is judged that the type of the second picture is not the Sync type (the step 102: No), it is judged whether or not the stream number of the second picture of the Sync type is stored as the valid stream number in the memory 355 or the memory 360, before the second picture of the Async type is selected in the step S101, under the control of the CPU 354 or the CPU 359, which constitute one specific example of the “second judging device” of the present invention (step S105).

As a result of the judgment in the step S105, if it is judged that the stream number of the second picture of the Sync type is stored as the valid stream number in the memory 355 or the memory 360 (the step S105: Yes), the stream number of the second picture of the Sync type is stored under the control of the CPU 354 or the CPU 359 (step S106). Alternatively, the stream number of the second picture of the Sync type is stored as the invalid stream number in the memory 355 or the memory 360, under the control of the CPU 354 or the CPU 359. The stream number of the second picture of the Sync type (in other words, the invalid stream number) is preferably stored by using another area different from the area for storing the valid stream number, in the memory 355 or the memory 360.

After that, the stream number of the second picture of the Sync type selected in the step S101 is stored as the valid stream number into the memory 355 or the memory 360 (step S107).

On the other hand, as a result of the judgment in the step S105, if it is judged that the stream number of the second picture of the Sync type is not stored as the valid stream number in the memory 355 or the memory 360 (the step S105: No), the stream number of the second picture of the Sync type selected in the step S101 is stored as the valid stream number into the memory 355 or the memory 360, without the operation in the step S106 (the step S107).

After that, the second picture of the Async type selected is reproduced as explained in FIG. 7 (step S108). As a result, the second picture is superimposed and displayed on the first picture as explained in FIG. 8.

Then, it is judged whether or not the display of the second picture of the Async type is to be ended (step S109). For example, it is judged whether or not the user has given an instruction to end the display of the second picture of the Async type, or whether or not the display period of the second picture of the Async type is over.

As a result of the judgment in the step S109, if it is judged that the display of the second picture of the Async type is not to be ended (the step S109: No), the operational flow returns to the step S108 again to continue the display of the second picture of the Async type.

On the other hand, as a result of the judgment in the step S109, if it is judged that the display of the second picture of the Async type is to be ended (the step S109: Yes), the display of the second picture is ended, and the stream number of the second picture of the Sync type stored in the step S106 (in other words, stored as the invalid stream number) is stored again as the valid stream number into the memory 355 or the memory 360, under the control of the CPU 354 or the CPU 359 (step S110).

Incidentally, if the operation in the step S106 is not performed, the operation in the step S110 is not performed, and the stream number of the second picture of the Async type stored in the step S107 continues to be stored as the valid stream number in the memory 355 or the memory 360. Of course, the stream number of the second picture of the Async type stored in the step S107 may be destroyed (or stored as the invalid stream number).

Now, a specific explanation is given by using a timing chart. As shown in FIG. 10, after the display of the first picture is started, the second picture of the Sync type is displayed in a reproduction period T1 set in advance. At this time, the stream number of the second picture of the Sync type, “11”, is stored as the valid stream number into the memory 355 or the memory 360. Then, even after the display of the second picture of the Sync type is ended after the reproduction time point t2, the stream number of the second picture of the Sync type, “11”, continues to be stored as the valid stream number in the memory 355 or the memory 360. Therefore, if the user does not give an instruction not to display the second picture, the second picture of the Sync type with the stream number of 11 is automatically displayed at a reproduction time point t5.

At this time, it is assumed that at the reproduction time t3, the user gives an instruction to display the second picture of the Async type. In this case, before the second picture of the Async type is displayed, the stream number of the second picture of the Sync type, “11”, is stored as the valid stream number in the memory 355 or the memory 360. Therefore, at the time point that the instruction is given to display the second picture of the Async type, the stream number of “11” is stored, and a new stream number, “21”, is stored as the valid stream number into the memory 355 or the memory 360. Then, the second picture of the Async type is displayed in a period T2.

After the display of the second picture of the Async type is ended at a reproduction time point t4, the stored stream number of the second picture of the Sync type, “11”, is stored again as the valid stream number into the memory 355 or the memory 360. As a result, even if the second picture of the Async type is displayed, the second picture of the Sync type with the stream number of “11” is automatically displayed at the time point of t5. That is, even if the second picture of the Async type is displayed, the second picture of the Sync type is automatically displayed without the user's instruction to display the second picture of the Sync type again.

Incidentally, the second picture of the Async type is often used as e.g. a background picture of a popup menu because it can be freely displayed at the reproduction time point desired by the user. On the other hand, the second picture of the Sync type is often used as a picture closely related to the first picture (e.g. strongly related to a scene of the first picture) because it is displayed at the reproduction time point determined in advance. Thus, even if the user who watches the first picture as well as the second picture of the Sync type happens to display the popup menu, which uses the second picture of the Async type as the background picture, and performs some operation or the like, the user can watch the first picture again with the second picture of the Sync type without any particular operation.

As described above, according to the information recording/reproducing apparatus 200 in the example, it is possible to preferably display the second picture, which is the sub-picture, superimposed and displayed on the first picture, which is the main picture.

Incidentally, in the aforementioned example, an explanation is given on the optical disc 100 as one example of the information recording medium and the player related to the optical disc 100 as one example of the information reproducing apparatus; however, the present invention is not limited to the optical disc and the player for the optical disc, and it can be also applied to other various information recording media which support high-density recording or high transmission rate, and players for the various information recording media.

Moreover, obviously, not only the information recording/reproducing apparatus for reproducing the AV content(s) recorded on the topical disc 100 but also an information recording/reproducing apparatus for reproducing the AV content(s) received through a wired line or wireless line, such as TV broadcasting and the Internet, can receive the aforementioned various benefits by performing the aforementioned operations.

The present invention is not limited to the aforementioned embodiment, but various changes may be made, if desired, without departing from the essence or spirit of the invention which can be read from the claims and the entire specification. An information reproducing apparatus and method, and a computer program, all of which involve such changes, are also intended to be within the technical scope of the present invention.

### INDUSTRIAL APPLICABILITY

The information reproducing apparatus and method, and the computer program according to the present invention can be applied to an information reproducing apparatus, such as a DVD player. Moreover, they can be applied to an information reproducing apparatus or the like which is mounted on various computer equipment for consumer use or for commercial use, or which can be connected to various computer equipment.

1-8. (canceled)

9. An information reproducing apparatus comprising:
a displaying device for displaying a main picture, a sub-picture of a first type, which is superimposed and displayed on the main picture and whose display can be started by an instruction of an user at a desired reproduction time point on a reproduction time axis of the main picture, and a sub-picture of a second type, which is superimposed and displayed on the main picture and in which display period is set in advance with respect to the reproduction time axis of the main picture;
a setting device for setting an identification number of the sub-picture of the first type or the sub-picture of the second type selected to be superimposed and displayed on the main picture, to a valid number; and
a controlling device for controlling said setting device to set the identification number of the sub-picture of the second type, which is selected before selection of the sub-picture of the first type, to the valid number after the display of the sub-picture of the first type is ended, if the sub-picture of the first type is selected and if the identification number of the sub-picture of the second type is set as the valid number before the selection of the sub-picture of the first type,
said displaying device superimposing and displaying the sub-picture corresponding to the identification number, which is set to the valid number, on the main picture.

10. The information reproducing apparatus according to claim 9, wherein said controlling device controls said setting device to continue to set the identification number of the sub-picture of the second type to the valid number after the display of the sub-picture of the second type is ended, if the sub-picture of the second type is selected.

11. The information reproducing apparatus according to claim 9, wherein said controlling device controls said setting device to continue to set the identification number of the sub-picture of the first type to the valid number after the display of the sub-picture of the first type is ended, if the sub-picture of the first type is selected and if the sub-picture of the second type is not selected before the selection of the sub-picture of the first type.

12. The information reproducing apparatus according to claim 9, wherein said controlling device controls said setting device to set the identification number of the sub-picture of the second type, which is set as the valid number before the selection of the sub-picture of the first type, to the valid number again after the display of the sub-picture of the first type is ended, if the sub-picture of the first type is selected and if the identification number of the sub-picture of the second type is set to the valid number before the selection of the sub-picture of the first type.

13. The information reproducing apparatus according to claim 9, further comprising a first judging device for judging whether the sub-picture of the first type is selected or the sub-picture of the second type is selected.

14. The information reproducing apparatus according to claim 9, further comprising a second judging device for judging, if the sub-picture of the first type is selected, whether or not the sub-picture of the second type is selected before the selection.

15. An information reproducing method in an information reproducing apparatus comprising: a displaying device for displaying a main picture, a sub-picture of a first type, which is superimposed and displayed on the main picture and whose display can be started by an instruction of an user at a desired reproduction time point on a reproduction time axis of the main picture, and a sub-picture of a second type, which is superimposed and displayed on the main picture and in which display period is set in advance with respect to the reproduction time axis of the main picture; and a setting device for setting an identification number of the sub-picture of the first type or the sub-picture of the second type selected to be superimposed and displayed on the main picture, to a valid number, said information reproducing method comprising:
a displaying process of displaying at least one of the main picture the sub-picture of the first type, and the sub-picture of the second type; and
a controlling process of controlling said setting device to set the identification number of the sub-picture of the second type, which is selected before selection of the sub-picture of the first type, to the valid number after the display of the sub-picture of the first type is ended, if the sub-picture of the first type is selected and if the identification number of the sub-picture of the second type is set as the valid number before the selection of the sub-picture of the first type,
said displaying process superimposing and displaying the sub-picture corresponding to the identification number, which is set to the valid number, on the main picture.

16. A computer program product in a computer-readable medium for tangibly embodying a program of instructions executable by a computer provided in the information reproducing apparatus according to claim 9, said computer program making the computer function as at least said controlling device.
